(19) United States
(12) Patent Application Publication
(10) Pub. No.: US 2013/0050430 A1
(43) Pub. Date: Feb. 28, 2013

(54) IMAGE PHOTOGRAPHING DEVICE AND CONTROL METHOD THEREOF

(71) Applicant: Seung Yun Lee, Hwaseong-si (KR)

(72) Inventor: Seung Yun Lee, Hwaseong-si (KR)

(73) Assignee: Samsung Electronics Co., Ltd., Suwon-si (KR)

(21) Appl. No.: 13/571,664

(22) Filed: Aug. 10, 2012

(30) Foreign Application Priority Data
Aug. 30, 2011 (KR) 10-2011-0087157

(51) Int. Cl. H04N 13/02

(52) U.S. Cl. 348/46; 348/E13.074

(57) ABSTRACT

An image photographing device includes a photographing unit that receives an image, an image processing unit that generates preview image data using the image, a depth map generation unit that receives the preview image data transmitted from the image processing unit and that generates a depth map of a subject using the preview image data, and a display unit that displays both the preview image data and information regarding the depth map of the subject through a preview image. A control method of an image photographing device includes generating preview image data using an image input during a 3D photographing mode, generating a depth map of a subject using the preview image data, and displaying both the preview image data and information regarding the depth map of the subject through a preview image.

### CROSS-REFERENCE TO RELATED APPLICATION

This application claims the benefit of Korean Patent Application No. 2011-0087157, filed on Aug. 30, 2011 in the Korean Intellectual Property Office, the disclosure of which is incorporated herein in its entirety by reference.

### BACKGROUND

1. Field

Embodiments relate to an image photographing device which may photograph a 3D image, and a control method thereof.

2. Description of the Related Art

In general, an image photographing device captures an image using light reflected by a subject. The image photographing device can be implemented as a type of multimedia equipment that can photograph a picture or a moving picture or that can reproduce a music file or a moving picture file.

Various new trials in terms of hardware or software are applied to the image photographing device implemented as a type of multimedia equipment to execute complicated functions. For example, user interface environments allowing a user to easily and conveniently search or select a function can be implemented, and a double-sided LCD or a front touchscreen can be implemented.

Such an image photographing device may have a function of generating a 3D image through image processing of a photographed image. If the image photographing device provides a 3D photographing mode to generate a 3D image, the image photographing device may provide a preview function to intuitively judge a photographing direction, etc.

### SUMMARY

Therefore, it can be an aspect to provide an image photographing device which can provide a preview function of depth data of an image of a subject during a 3D photographing mode, and a control method thereof.

Additional aspects will be set forth in part in the description which follows and, in part, will be obvious from the description, or may be learned by practice of the invention.

In accordance with one aspect, a control method of an image photographing device includes generating preview image data using an image input during a 3D photographing mode, generating a depth map of a subject using the preview image data, and displaying both the preview image data and information regarding the depth map of the subject through a preview image.

The generating of the depth map using the preview image data can include extracting characteristic information of the preview image data and generating the depth map of the preview image data using the characteristic information.

The characteristic information may include at least one of edge information, color information, luminance information, motion information, and histogram information of the subject.

The generating of the depth map using the preview image data may include reducing a size of the preview image data through resizing of the preview image data and generating the depth map of the preview image data using the preview image data having the reduced size.

The information regarding the depth map of the subject may include information formed by executing color processing of the depth map of the subject.

The information formed by executing color processing of the depth map of the subject may include information in which a sense of distance is expressed by changing brightness of a random color according to depth information of respective pixels of the subject.

The information formed by executing color processing of the depth map of the subject may include information in which a sense of distance is expressed using a first color applied to pixels of the subject located at a long distance, a second color applied to pixels of the subject located at a short distance, and a third color, brightness of which is changed from the pixels located at the long distance to the pixels located at the short distance.

The information formed by executing color processing of the depth map of the subject may include information in which, if a depth difference between neighboring pixels of the subject is within a predetermined range, the pixels are grouped as having a same distance information.

The information regarding the depth map of the subject may include a depth gauge graph representing depth information regarding respective pixels of the preview image data.

The control method may further include displaying a warning, if a level of 3D effects exhibited by 3D photographing is lower than a reference level as a result of confirmation of a depth map data of the subject.

In accordance with another aspect, an image photographing device includes a photographing unit that receives an image, an image processing unit that generates preview image data using the image, a depth map generation unit that receives the preview image data transmitted from the image processing unit and that generates a depth map of a subject using the preview image data, and a display unit that displays both the preview image data and information regarding the depth map of the subject through a preview image.

The depth map generation unit may reduce a size of the preview image data through resizing of the preview image data and generate the depth map of the preview image data using the preview image data having the reduced size.

The image processing unit may receive the depth map transmitted from the depth map generation unit and execute color processing according to depth information regarding respective pixels of the preview image data.

The image processing unit may execute color processing in which a sense of distance is expressed by changing brightness of a random color according to depth information of respective pixels of the subject.

The image processing unit may execute color processing in which a sense of distance is expressed using a first color applied to pixels of the subject located at a long distance, a second color applied to pixels of the subject located at a short distance, and a third color, brightness of which is changed from the pixels located at the long distance to the pixels located at the short distance.

The image processing unit may execute color processing in which, if a depth difference between neighboring pixels of the subject is within a predetermined range, the pixels are grouped as having a same distance information.

The image processing unit may receive the depth map transmitted from the depth map generation unit and generate a depth gauge graph according to depth information regarding respective pixels of the preview image data.

### BRIEF DESCRIPTION OF THE DRAWINGS

These and/or other aspects will become apparent and more readily appreciated from the following description of the embodiments, taken in conjunction with the accompanying drawings of which:

FIG. 1 is a perspective view of an image photographing device in accordance with an embodiment;

FIG. 2 is a rear view of the image photographing device shown in FIG. 1;

FIG. 3 is a control block diagram of the image photographing device in accordance with an embodiment;

FIG. 4A is a view illustrating a preview image of the image photographing device in accordance with an embodiment;

FIG. 4B is a view illustrating color processing executed by changing brightness of a single color according to depth data of the preview image of the image photographing device in accordance with an embodiment;

FIG. 4C is a view illustrating color processing executed by changing kinds and brightnesses of plural colors according to depth data of the preview image of the image photographing device in accordance with an embodiment;

FIGS. 5A and 5B are depth gauge graphs according to depth data of the preview image of the image photographing device in accordance with an embodiment;

FIG. 6 is a control block diagram of a depth map generation unit of the image photographing device in accordance with an embodiment;

FIG. 7 is a detailed control block diagram of the depth map generation unit of the image photographing device in accordance with an embodiment;

FIG. 8 is a view illustrating a depth map displayed in a preview image of the image photographing device in accordance with an embodiment;

FIG. 9 is a view illustrating a depth gauge graph displayed in a preview image of the image photographing device in accordance with an embodiment;

FIG. 10 is a view illustrating an warning displayed in the preview image of the image photographing device in accordance with an embodiment; and

FIG. 11 is a flowchart illustrating a method of outputting data of the depth map to the preview image in the image photographing device in accordance with an embodiment.

### DETAILED DESCRIPTION

Reference will now be made in detail to the embodiments, examples of which are illustrated in the accompanying drawings, wherein like reference numerals refer to like elements throughout.

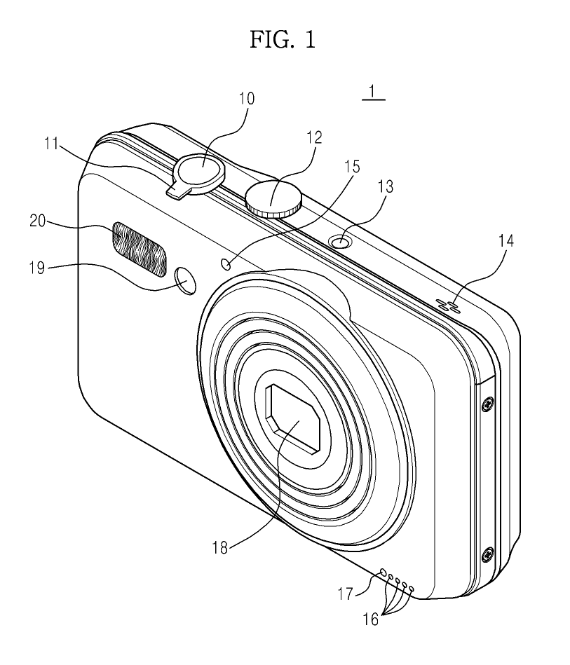

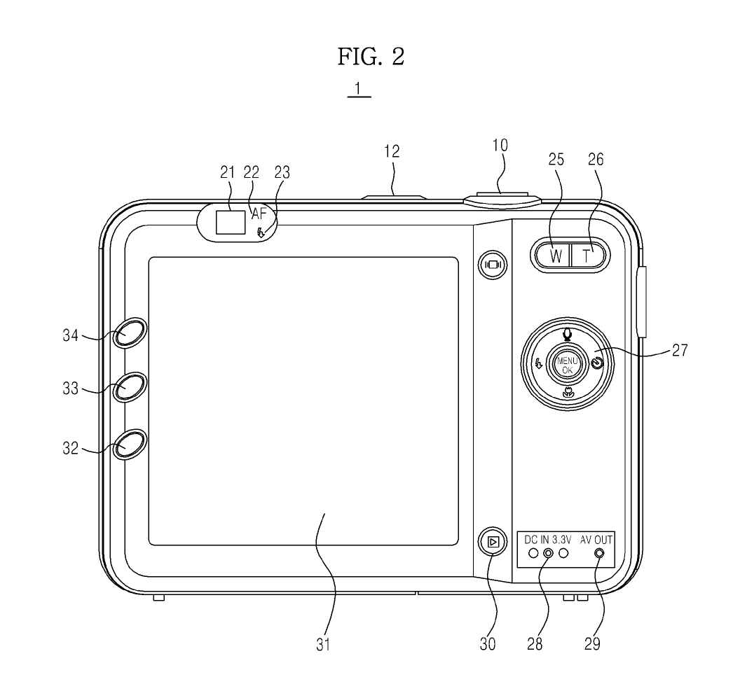

FIG. 1 is a perspective view of an image photographing device in accordance with one embodiment, and FIG. 2 is a rear view of the image photographing device shown in FIG. 1.

With reference to FIG. 1, an image photographing device 1 in accordance with this embodiment can include a shutter button 10 that can execute a photographing operation, a jog dial 11 that can adjust menu settings, a mode dial 12 that can set a photographing mode, a power switch 13 that can turn power on/off, a speaker 14 that can output sound, an auto-focus sub light 15 that can emit light during auto-focusing, a microphone 16 that can input voice, a remote controller receiving unit 17 that can receive a signal from a remote controller, a lens 18 that can photograph an image of a subject, a view finder lens 19 that can be provided to preview the image photographed by the image photographing device 1, and a flash 20 that can emit light.

With reference to FIG. 2, the image photographing device 1 can include a view finder 21 that can preview the image photographed by the image photographing device 1, an auto-focus lamp 22 and a flash state lamp 23 that can respectively represent an auto-focusing state and a flash state, an LCD button 24 that can turn an LCD on/off, a wide field-of-view zoom button 25 and a telephoto zoom button 26 that can respectively support a wide field-of-view zoom function and a telephoto zoom function, a function button 27 that can set or release various functions, a DC input terminal 28, an external output terminal 29, a reproduction mode button 30, an LCD monitor 31, a manual focus button 32, an auto exposure locking button 33, and an image quality adjustment button 34.

The LCD monitor 31 may be an on screen display (OSD) which can display current photographing mode and state of the image photographing device 1, and will be referred to as a display unit 31 hereinafter.

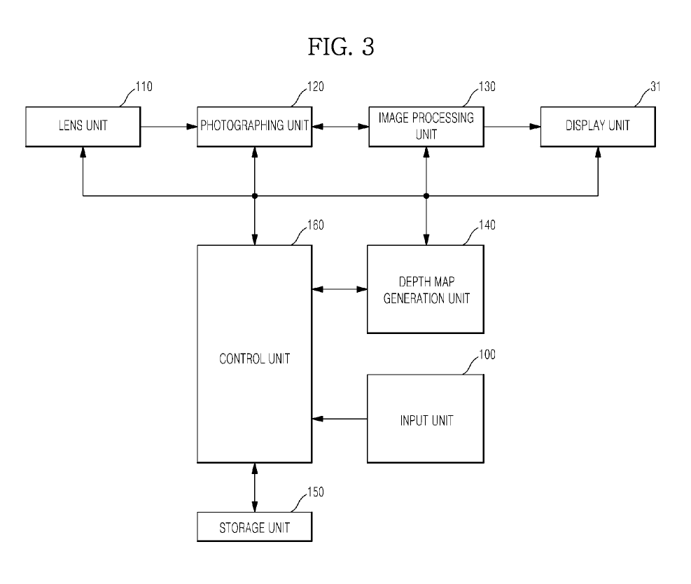

FIG. 3 is a control block diagram of the image photographing device in accordance with an embodiment.

The image photographing device 1 can include an input unit 100, a lens unit 110, a photographing unit 120, an image processing unit 130, the display unit 31, a depth map generation unit 140, a storage unit 150, and a control unit 160.

The input unit 100 can include various keys shown in FIGS. 1 and 2. The input unit 100 may include the mode dial 12 that can set a photographing mode of the image photographing device 1. The photographing mode may include a 2D photographing mode or a 3D photographing mode. The input unit 100 may output a key input signal corresponding to a key input by a user to the control unit 160.

The photographing unit 120 may include the lens unit 110 which can be retractable and extendible. The photographing unit 120 may obtain image data through the lens unit 110. The photographing unit 120 may include a camera sensor (not shown) that can convert a photographed optical signal into an electrical signal, and a signal processing unit (not shown) that can convert analog data photographed by the camera sensor into digital data.

The image processing unit 130 can convert raw image data in the unit of a frame received from the photographing unit 120 into RGB or YUV data which can enable image processing, and can execute operations for image processing, such as auto exposure, white balance, auto-focus, noise removal, etc. The image processing unit 130 may compress image data output from the photographing unit 120 in a manner set according to the characteristics and size of the display unit 31, or may restore compressed data to original image data. It is assumed that the image processing unit 130 can have an OSD function, and the image processing unit 130 may output preview image data according to the size of a displayed screen.

The image processing unit 130 may output depth data of a subject together with the preview image data during the 3D photographing mode. The depth data may include depth map data or a depth gauge. The depth map data can be generated by the depth map generation unit 140, which will be described later, and the depth gauge may be generated using the depth map data.

When the image processing unit 130 receives the depth map data from the depth map generation unit 140, the image processing unit 130 may execute color processing according to depth data of respective pixels of the preview image data.

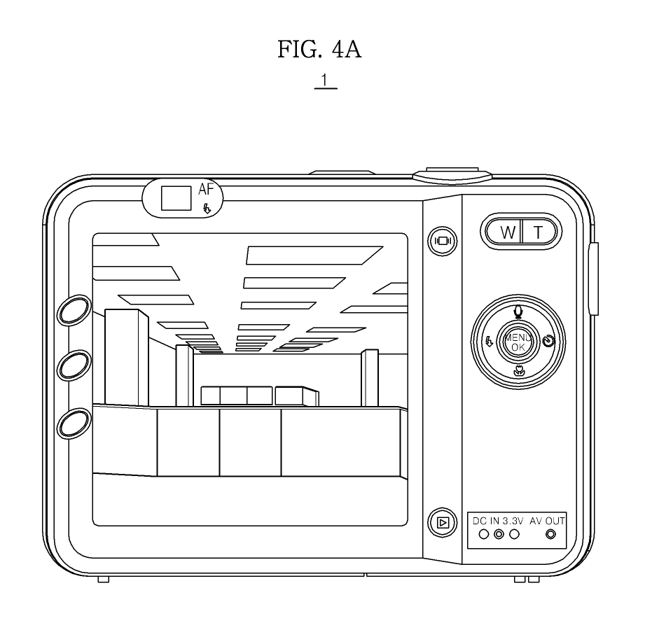

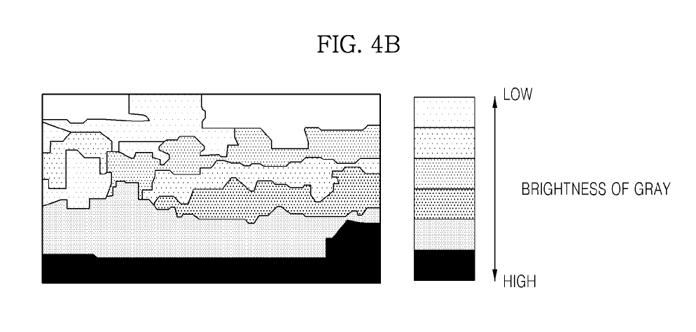

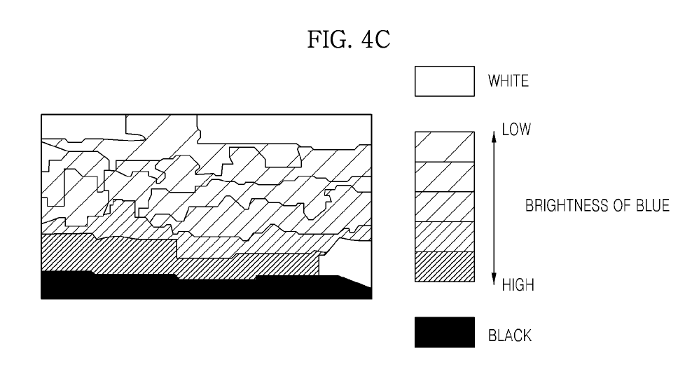

When the image processing unit 130 receives depth data of the respective pixels from the depth map generation unit 140, the image processing unit 130 may group the depth data of the respective pixels. The image processing unit 130 may express the grouped pixels in light gray if the depth of the grouped pixels is large, and the image processing unit 130 may express the grouped pixels in dark gray if the depth of the grouped pixels is small, thereby generating an image having a sense of distance. In more detail, if a depth difference between neighboring pixels is within a predetermined range, the image processing unit 130 can group the pixels as having the same distance information and can express the grouped pixels in gray having the same brightness. FIG. 4A is a view illustrating preview image data, and FIG. 4B is a view illustrating generation of an image having a sense of distance by expressing the preview image data in gray. As shown in FIG. 4B, pixels of the preview image data of FIG. 4A can be grouped so that gray colors having similar brightnesses may be arranged along the Y axis. However, although gray is exemplarily used, other random colors expressing light and darkness may be used.

When the image processing unit 130 receives depth data of the respective pixels from the depth map generation unit 140, the image processing unit 130 can group the depth data of the respective pixels and then can express the pixels in colors in the real world. In more detail, if a depth difference between neighboring pixels is within a predetermined range, the image processing unit 130 can group the neighboring pixels as having the same distance information and can express the grouped pixels in the same color, thereby generating an image having a sense of distance. In more detail, the image processing unit 130 may execute color processing to express the sense of distance using a color applied to a long distance, a color applied to a short distance, and a color having brightness varied from the long distance to the short distance according to depth data of respective pixels of a subject. For example, the image processing unit 130 may apply black to pixels grouped as having the short distance, apply white to pixels grouped as having the long distance, and apply blue having a concentration which is adjusted as being distant from the short distance.

FIG. 4A is a view illustrating preview image data in the preview image, and FIG. 4C is a view illustrating generation of an image having the sense of distance by expressing the preview image data in plural colors. As shown in FIG. 4C, pixels of the preview image data of FIG. 4A can be grouped so that similar colors and colors having similar brightnesses may be arranged along the Y axis.

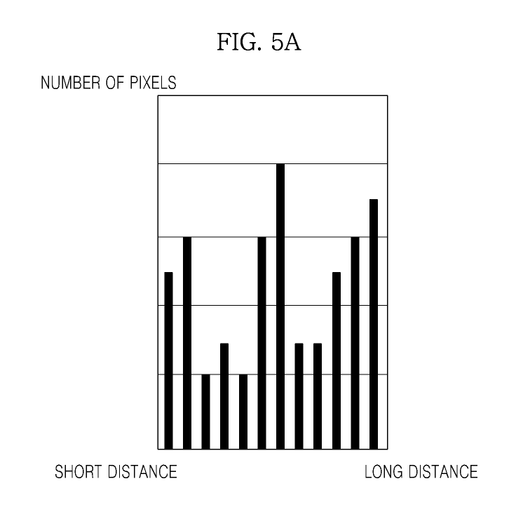

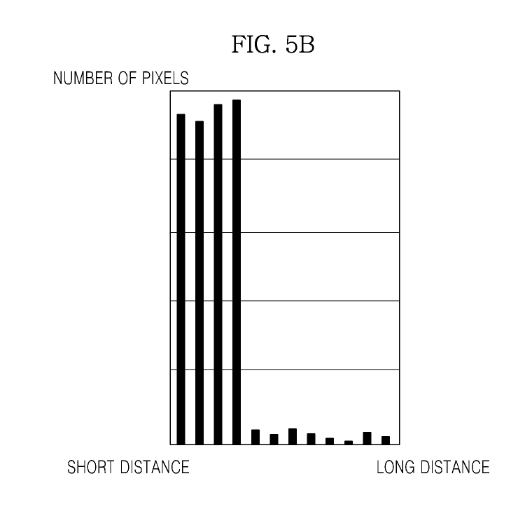

The image processing unit 130 may generate a depth gauge according to depth map data. The image processing unit 130 may generate a depth gauge graph illustrating a distance distribution of pixels located at a short distance to pixels located at a long distance according to the depth map data. FIGS. 5A and 5B are graphs illustrating a number distribution of pixels according to distances from the image photographing device 1. FIG. 5A illustrates that the distances of the respective pixels of the preview image data can be uniformly distributed and thus shows that an image having excellent 3D effects may be photographed. FIG. 5B illustrates that most pixels can be located at a short distance and thus shows that an image having poor 3D effects may be photographed. A user may set a photographing direction and a photographing angle with reference to a distance gauge graph during the 3D photographing mode.

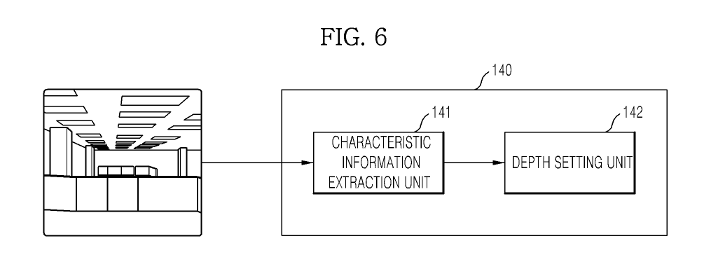

The depth map generation unit 140 may generate a depth map of a subject using the preview image data. With reference to FIG. 6, the depth map generation unit 140 may include a characteristic information extraction unit 141 and a depth setting unit 142.

The characteristic information extraction unit 141 can extract characteristic information the preview image data. The characteristic information may include edge information, color information, luminance information, motion information, or histogram information. The depth setting unit 142 can generate depth values of the preview image data using the characteristic data extracted by the characteristic data extraction unit 141.

The depth map generation unit 140 may set depth values of a subject based on the characteristic information of the preview image data. The depth map generation unit 140 may reduce the size of the preview image data through resizing, and may set the depth values of the subject from the preview image data having the reduced size.

The control unit 160 can generally control operations of the respective function units. The control unit 160 may process an external signal input through the photographing unit 120 and can output an image output signal required for various operations including display of a photographed image through the display unit 31.

The control unit 160 can control the depth map generation unit 140 to generate the depth map, when a user selects the 3D photographing mode through the input unit 100. The control unit 160 can control the image processing unit 130 and the display unit 31 to display information regarding the depth map of the subject through the preview image, before a still cut in the 3D photographing mode can be photographed. The depth map can represent distance information of the subject. The user can judge 3D effects in advance and then can photograph a still cut to generate a 3D image.

The control unit 160 may display a warning, upon judging that a level of the 3D effects according to the depth map or the depth gauge information upon which color processing has been executed is lower than a reference level. For example, the control unit 160 may display a warning stating that 3D photographing is difficult, if gray having one concentration is expressed in the depth map or one color (white or black) is expressed in the depth map.

The control unit 160 may convert a still cut photographed in the 2D photographing mode into 3D data. The control unit 160 can execute rendering by adding the depth information to a 2D image, and thus can convert the 2D image into 3D data. That is, the control unit 160 can render the 3D image from the input 2D image using depth values of the preview image data set based on the characteristic information of the preview image data, thereby converting the 2D image into the 3D image.

The storage unit 150 may include a program memory and a data memory. The storage unit 150 may store various information required to control operation of the image photographing device 1 or information selected by a user. The data memory may store photographed image data, and the program memory may store a program to control the lens unit 110.

The display unit 31 may display the depth map of the depth gauge graph upon which color processing has been executed together with the preview image data, when the image photographing device 1 enters the 3D photographing mode.

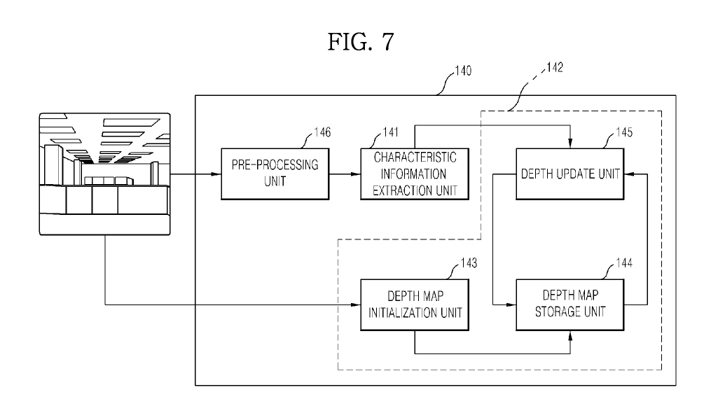

FIG. 7 is a detailed control block diagram of the depth map generation unit of the image photographing device in accordance with an embodiment.

The depth map generation unit 140 may include a pre-processing unit 146, the characteristic information extraction unit 141, and the depth setting unit 142.

The pre-processing unit 146 may convert a color space of the preview image data or extract motion vectors of the preview image data by decoding the preview image data, if the preview image data is an image encoded into a predetermined video stream.

If the pre-processing unit 146 converts the color space of the preview image data or extracts the motion vectors of the preview image data, the characteristic information extraction unit 141, which will be described later, may more precisely extract characteristic information. For example, if the preview image data is an image formed of an RGB color space, the pre-processing unit 146 can convert the color space of the preview image data into an LUV color space, thereby allowing the characteristic information extraction unit 141 to more precisely extract the characteristic information of the preview image data.

The depth setting unit 142 may include a depth map initialization unit 143, a depth update unit 145, and a depth map storage unit 144.

The depth map initialization unit 143 may set an initial depth value of the preview image data every frame and may store the set initial depth value in the map storage unit 144. The depth map initialization unit 143 may set the initial depth value using Equation 1 below.

z(x,y)=y/N Equation 1

Here, x and y can mean image coordinates forming the preview image data, and z means a depth value. z may be a value in the range of 0 to 1 according to a distance of a subject from the image photographing device 1 expressed by the preview image data. For example, if the subject is located at a long distance from the image photographing device 1, the depth can have a large value close to 1. If the subject is located at a short distance from the image photographing device 1, the depth can have a small value close to 0. N can mean the number of horizontal lines of the image forming the preview image data.

From Equation 1, it is understood that the initial depth value can depend on the y coordinate value of the image forming the preview image data. The reason for this can be that, from among subjects expressed by the preview image data, the subject located at the upper end of the preview image data can be generally located at a longer distance from the image photographing device 1 than the subject located at the lower end of the preview image data. Thereby, the initial depth value may be set through a method of increasing the depth of the subject located at the upper end of the preview image data to be greater than the depth of the subject located at the lower end of the preview image data.

The characteristic information extraction unit 141 may extract at least one piece of the characteristic information of the preview image data and can supply the extracted at least one piece of the characteristic information to the update unit 145. The characteristic information may be edge information, color information, luminance information, motion information, or histogram information.

The characteristic information extraction unit 141 may calculate weights between at least one pixel forming the preview image data and pixels adjacent to the at least one pixel based on the at least one piece of the characteristic information. The characteristic information extraction unit 141 may calculate the weights depending upon similarity of the characteristic information between the at least one pixel and the adjacent pixels.

The depth update unit 145 may execute filtering in consideration of the weights calculated by the characteristic information extraction unit 141.

For example, the characteristic information extraction unit 141 may extract luminance information of the preview image data. The characteristic information extraction unit 141 may calculate the weights between the at least one pixel and the adjacent pixels forming the preview image data based on similarity of the luminance information. In more detail, the characteristic information extraction unit 141 may calculate weights between a pixel a forming the preview image data and pixels x, y, z and w adjacent to the pixel a. If differences in the similarities of luminance between the pixel a and the pixels, x, y, z and w are increasing in order of pixels, x, y, z and w, the characteristic information extraction unit 141 may determine sizes of the weights in order of the pixels, x, y, z and w. Thereafter, the depth update unit 145 can apply the weights calculated by the characteristic information extraction unit 141 to the initial depth values of the pixels, x, y, z and w stored in the depth map, thereby updating the depth values. In more detail, the depth update unit 145 can calculate a first depth value of the pixel a by applying the weight calculated by the characteristic information extraction unit 141 to the initial depth value of the pixel a and can update the initial depth value of the pixel a stored in the depth map storage unit 144 with the first depth value of the pixel a. In the same manner as the pixel a, the depth update unit 145 can calculate and can update the initial depth values of the pixels x, y, z and w with second depth values of the pixels x, y, z and w in consideration of weights between the pixels x, y, z and w and adjacent pixels.

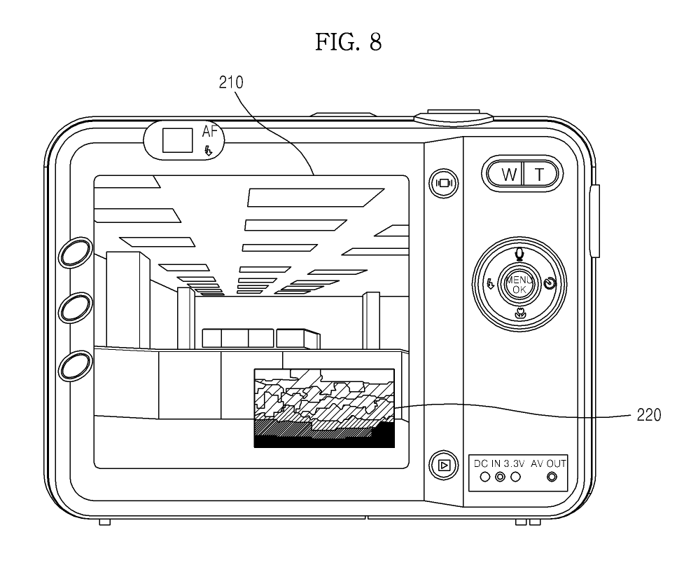

FIG. 8 is a view illustrating a preview image displayed on the display unit of the image photographing device in accordance with an embodiment.

When a user selects the 3D photographing mode, the control unit 160 may display a depth map 220 generated using preview image data 210. The preview image can be updated in real time, and the depth map 220 can be converted in real time according to the change of the preview image. The depth map 220 may display depth states according to concentrations of gray. Alternatively, the depth map 220 may display depth states using colors in the real world. Pixels located at a short distance from the image photographing device 1 can be expressed in black; pixels located at a long distance can be expressed in white; and a concentration of blue can be changed as pixels are distant from the short distance, thereby expressing the preview image like colors in the real world. The user may predict 3D effects with reference to the depth map 220. When various concentrations of gray are distributed or various colors in the real world are distributed in the depth map 220, a 3D image having excellent 3D effects may be generated.

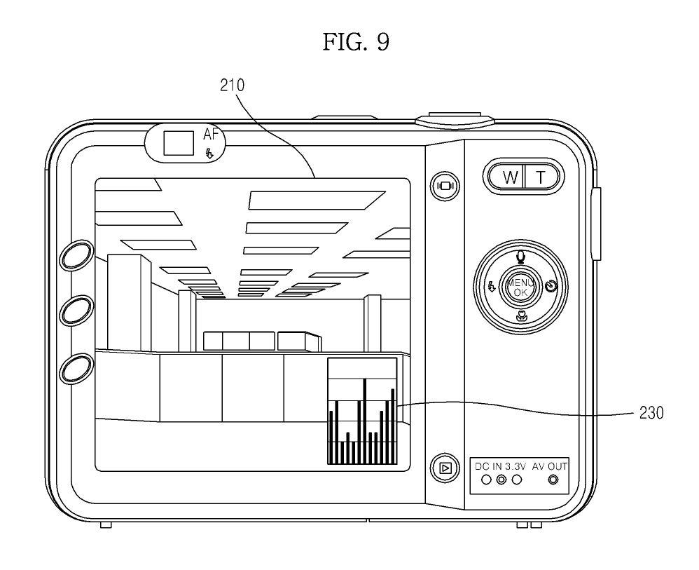

FIG. 9 is a view illustrating a preview image displayed on the display unit of the image photographing device in accordance with an embodiment.

When a user selects the 3D photographing mode, the control unit 160 may display preview image data 210 and a depth gauge graph 230. The depth gauge graph 230 may be generated using information included in a depth map formed using the preview image, and the depth map can be a depth map representing depth information of a subject. The depth gauge graph 230 can be a graph representing depth information according to distance information of the respective pixels of the preview image. Further, the depth gauge graph 230 can be a graph representing the number of the pixels corresponding to random distances from a long distance to a short distance. The user may predict 3D effects with reference to the depth gauge graph 230. When various pixels are distributed according to distances, 3D effects can be excellent, and when pixels according to distances are concentrated at a specific distance, 3D effects can be poor.

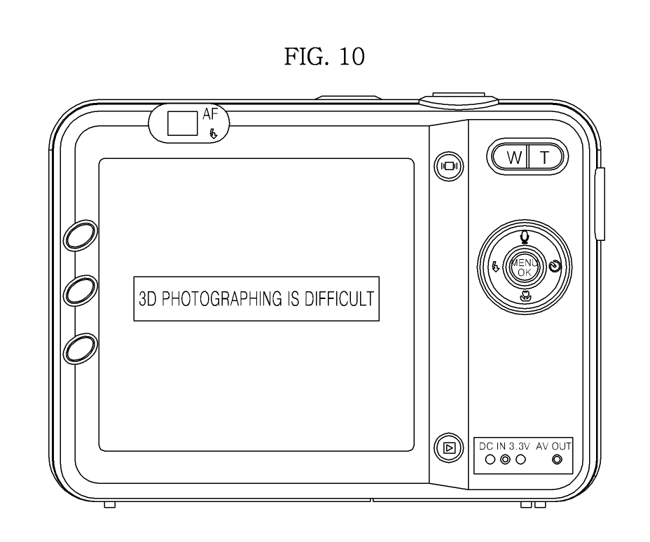

FIG. 10 is a view illustrating a warning displayed on the display unit of the image photographing device in accordance with an embodiment.

The control unit 160 may display the warning, upon judging that a level of the 3D effects according to the depth map or the depth gauge information shown in FIG. 8 or 9 is lower than a reference level. For example, the control unit 160 may display a warning stating that 3D photographing is difficult, if gray expressed in the depth map has one concentration or one color (white or black) is expressed in the depth map. With reference to FIG. 10, the control unit 160 may display the warning stating that 3D photographing is difficult, thereby catching the user's attention.

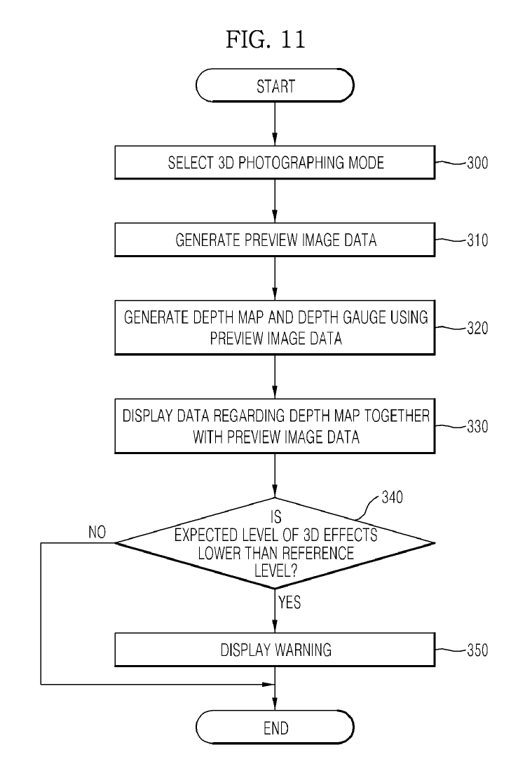

FIG. 11 is a flowchart illustrating a method of outputting a preview image during 3D photographing of the image photographing device in accordance with an embodiment.

The control unit 160 can control the image processing unit 130 to generate preview image data (Operation 310), when a user selects the 3D photographing mode through the input unit 100 (Operation 300).

The depth map generation unit 140 can receive the preview image data from the image processing unit 130 and can generate a depth map using the preview image data (Operation 320). The image processing unit 130 may receive depth map information, execute color processing, and generate a depth gauge graph (Operation 320).

The image processing unit 130 can display information regarding the depth map of a subject together with the preview image data through the display unit 31 (Operation 330).

The control unit 160 can display a warning (Operation 350), upon judging that a level of 3D effects expected or predicted according to the depth map information of the subject is lower than a reference level (Operation 340). In comparison of the expected or predicted level of 3D effects with the reference level, it can be judged that 3D photographing can be difficult if there is little color change between pixels expressed in the depth map or if only one color is expressed in the depth map. Thus, it can be judged that the level of 3D effects is lower than the reference level.

Although the above-described embodiment illustrates the image processing unit 130 as generating the depth gauge graph, the depth map generation unit 140 may generate the depth gauge graph using the depth map. Further, the depth map generation unit 140 may be designed to execute color processing of the depth map.

As is apparent from the above description, an image photographing device and a control method thereof in accordance with one embodiment can display information regarding a depth map of a subject together with a preview image during a 3D photographing mode, thereby allowing a user to recognize 3D effects prior to photographing.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. It will also be recognized that the terms “comprises,” “comprising,” “includes,” “including,” “has,” and “having,” as used herein, are specifically intended to be read as open-ended terms of art. The words “mechanism” and “element” are used broadly and are not limited to mechanical or physical embodiments, but may include software routines in conjunction with processors, etc. No item or component is essential to the practice of the invention unless the element is specifically described as “essential” or “critical”. Furthermore, recitation of ranges of values herein are merely intended to serve as a shorthand method of referring individually to each separate value falling within the range, unless otherwise indicated herein, and each separate value is incorporated into the specification as if it were individually recited herein. The use of any and all examples, or exemplary language (e.g., “such as”) provided herein, is intended merely to better illuminate the invention and does not pose a limitation on the scope of the invention unless otherwise claimed. Finally, the steps of all methods described herein can be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Also, the invention may employ any number of conventional techniques for electronics configuration, signal processing and/or control, data processing and the like. The apparatus described herein may comprise a processor, a memory for storing program data to be executed by the processor, a permanent storage such as a disk drive, a communications port for handling communications with external devices, and user interface devices, including a display, keys, etc.

When software modules are involved, these software modules may be stored as program instructions or computer readable code executable by the processor on a non-transitory computer-readable media, random-access memory (RAM), read-only memory (ROM), CD-ROMs, DVDs, magnetic tapes, hard disks, floppy disks, and optical data storage devices. The computer readable recording media may also be distributed over network coupled computer systems so that the computer readable code is stored and executed in a distributed fashion. This media can be read by the computer, stored in the memory, and executed by the processor. Where elements of the invention are implemented using software programming or software elements, the invention may be implemented with any programming or scripting language such as C, C++, Java, assembler, or the like, with the various algorithms being implemented with any combination of data structures, objects, processes, routines or other programming elements. Also, using the disclosure herein, programmers of ordinary skill in the art to which the invention pertains can easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Functional aspects may be implemented in algorithms that execute on one or more processors. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device.

While the present invention has been particularly shown and described with reference to exemplary embodiments thereof, it will be understood that numerous modifications and adaptations will be readily apparent to those of ordinary skill in this art without departing from the spirit and scope of the present invention as defined by the following claims. Although a few exemplary embodiments of the present invention have been particularly shown and described with reference to exemplary embodiments thereof, it would be appreciated by those skilled in the art that numerous modifications, adaptations, and changes may be made in these embodiments without departing from the principles and spirit of the invention. Therefore, the scope of the invention is defined not by the detailed description of the invention but by the following claims, and all differences within the scope will be construed as being included in the invention.

What is claimed is:

1. A control method of an image photographing device comprising:
generating preview image data using an image input during a 3D photographing mode;
generating a depth map of a subject using the preview image data; and
displaying both the preview image data and information regarding the depth map of the subject through a preview image.

2. The control method according to claim 1, wherein the generating of the depth map using the preview image data includes extracting characteristic information of the preview image data and generating the depth map of the preview image data using the characteristic information.

3. The control method according to claim 2, wherein the characteristic information includes at least one of edge information, color information, luminance information, motion information, and histogram information of the subject.

4. The control method according to claim 1, wherein the generating of the depth map using the preview image data includes reducing a size of the preview image data through resizing of the preview image data and generating the depth map of the preview image data using the preview image data having the reduced size.

5. The control method according to claim 1, wherein the information regarding the depth map of the subject includes information formed by executing color processing of the depth map of the subject.

6. The control method according to claim 5, wherein the information formed by executing color processing of the depth map of the subject includes information in which a sense of distance is expressed by changing brightness of a random color according to depth information of respective pixels of the subject.

7. The control method according to claim 5, wherein the information formed by executing color processing of the depth map of the subject includes information in which a sense of distance is expressed using a first color applied to pixels of the subject located at a long distance, a second color applied to pixels of the subject located at a short distance, and a third color, brightness of which is changed from the pixels located at the long distance to the pixels located at the short distance.

8. The control method according to claim 5, wherein the information formed by executing color processing of the depth map of the subject includes information in which, if a depth difference between neighboring pixels of the subject is within a predetermined range, the pixels are grouped as having a same distance information.

9. The control method according to claim 1, wherein the information regarding the depth map of the subject includes a depth gauge graph representing depth information regarding respective pixels of the preview image data.

10. The control method according to claim 1, further comprising displaying a warning, if a level of 3D effects exhibited by 3D photographing is lower than a reference level as a result of confirmation of a depth map data of the subject.

11. An image photographing device comprising:
a photographing unit that receives an image;
an image processing unit that generates preview image data using the image;
a depth map generation unit that receives the preview image data transmitted from the image processing unit and that generates a depth map of a subject using the preview image data; and
a display unit that displays both the preview image data and information regarding the depth map of the subject through a preview image.

12. The image photographing device according to claim 11, wherein the depth map generation unit reduces a size of the preview image data through resizing of the preview image data and generates the depth map of the preview image data using the preview image data having the reduced size.

13. The image photographing device according to claim 11, wherein the image processing unit receives the depth map transmitted from the depth map generation unit and executes color processing according to depth information regarding respective pixels of the preview image data.

14. The image photographing device according to claim 13, wherein the image processing unit executes color processing in which a sense of distance is expressed by changing brightness of a random color according to depth information of respective pixels of the subject.

15. The image photographing device according to claim 13, wherein the image processing unit executes color processing in which a sense of distance is expressed using a first color applied to pixels of the subject located at a long distance, a second color applied to pixels of the subject located at a short distance, and a third color, brightness of which is changed from the pixels located at the long distance to the pixels located at the short distance.

16. The image photographing device according to claim 13, wherein the image processing unit executes color processing in which, if a depth difference between neighboring pixels of the subject is within a predetermined range, the pixels are grouped as having a same distance information.

17. The image photographing device according to claim 11, wherein the image processing unit receives the depth map transmitted from the depth map generation unit and generates a depth gauge graph according to depth information regarding respective pixels of the preview image data.
